(19) United States
(12) Patent Application Publication
(10) Pub. No.: US 2026/0101265 A1
(43) Pub. Date: Apr. 9, 2026

(54) SNR-BASED CONNECTION ADMISSION CONTROL

(71) Applicant: Comcast Cable Communications, LLC, Philadelphia, PA (US)

(72) Inventors: Naveen Kumar Raju Vysyaraju, Philadelphia, PA (US); Farman Ibayev, Philadelphia, PA (US); Soumya Munshi, Philadelphia, PA (US); Raja Shah, Philadelphia, PA (US)

(21) Appl. No.: 18/905,652

(22) Filed: Oct. 3, 2024

(51) Int. Cl. H04W 48/02; H04B 17/309; H04L 9/40; H04W 12/06

(52) U.S. Cl. CPC H04W 48/02; H04B 17/346; H04L 63/0892; H04W 12/06

(57) ABSTRACT

Methods may comprise receiving, at a network access point associated with a network, a request for access to the network from a user device. Based on an analysis of a signal between the user device and the network access point, a signal-to-noise ratio (SNR) may be determined. Access to the network may be based on at least a comparison of the SNR to a SNR threshold.

### BACKGROUND

A network provider may provide network access points to associated users. Such users may have varying experience in connectivity to the access points and the related network.

### SUMMARY

It is to be understood that both the following general description and the following detailed description are exemplary and explanatory only and are not restrictive. Methods and systems for managing wireless communications are described.

Methods may comprise receiving, at a network access point associated with a network, a request for access to the network from a user device. Based on an analysis of a signal between the user device and the network access point, a signal-to-noise ratio (SNR) may be determined. Access to the network may be based on at least a comparison of the SNR to a SNR threshold. Other embodiments of this aspect include corresponding computer systems, apparatus, and computer programs recorded on one or more computer storage devices, each configured to perform the actions of the methods.

### BRIEF DESCRIPTION OF THE DRAWINGS

Some features are shown by way of example, and not by limitation, in the accompanying drawings. In the drawings, like numerals reference similar elements.

FIG. 1 shows an example environment for SNR-based connection admission control.

FIG. 2 shows an example sequence diagram for SNR-based connection admission control.

FIG. 3 shows an example sequence diagram for SNR-based connection admission control.

FIG. 4 shows example authentication server packet information.

FIG. 5 shows example access reject packet information.

FIGS. 6A-6E show an example process for SNR-based connection admission control.

FIG. 7 shows an example method for SNR-based connection admission control.

FIG. 8 shows an example method for SNR-based connection admission control.

FIG. 9 shows an example method for SNR-based connection admission control.

FIG. 10 shows an example method for SNR-based connection admission control.

The accompanying drawings show examples of the disclosure. It is to be understood that the examples shown in the drawings and/or discussed herein are non-exclusive and that there are other examples of how the disclosure may be practiced.

### DETAILED DESCRIPTION

The present disclosure relates to systems and methods for network connection admission control based on a signal-to-noise ratio (SNR) between the user device and a network device of the network. As an illustrative example, selectively allowing or denying network connection admission based on an SNR threshold may improve a user connectivity experience on the network. Other advantages may be realized.

At least a portion of the admission control may be implemented via an authentication server such as an authentication, authorization, and accounting (AAA) server (e.g., a Remote Authentication Dial-In User Service (RADIUS) server). As such, the AAA server may reject admission to devices having an SNR below an SNR threshold based on the AAA server or other classification such as a region or group of devices being served by the AAA server. As used herein, a AAA server may be any network component configured to manage authentication, authorization, and accounting service in support of network service. The AAA server may be or comprise a network component configured to provision a set of services for controlling access to computer resources, enforcing policies, assessing usage, and/or providing the information necessary to bill for services.

When a user device is rejected for failing to meet or exceed the SNR threshold, the connection may be rejected. In an aspect, an error message (e.g., “SNR Value is less than allowed”/“412 low SNR/dication/ERR_SNR_DENY”) may be transmitted to the rejected user device so that the user may use alternative connections such as a cellular network or other known private WiFi network or hotspots with better connection for a better connectivity experience. Other actions may be taken or implemented.

A system of one or more devices such as computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by a data processing apparatus, cause the apparatus to perform the actions.

A user (e.g., subscriber) of a network may connect to network access points (e.g., hot spots, modems, Wi-Fi networks, gateways, etc.) associated with the network provider. However, the network access points may only allow access to a network if certain conditions are met. An example condition may be or comprise that a signal-to-noise ratio (SNR) between a user device (e.g., subscriber device) and a network access point from which the user device is requesting access is above an SNR threshold. If the SNR between the user device and the network access point is below the SNR threshold, then the connection may be weak, the user experience may be poor, and a brand associated with the network provider may suffer. Disconnecting the user device and forcing the user device to access a cellular network or a network access point with a better SNR may provide a better user experience for the user.

A user may use a first user device to connect to a network via a network access point. The user may request access to the network via the network access point as one would typically request to connect to a Wi-Fi network. The user may have one or more connection credentials (e.g., key, password, device media access control (MAC) address, etc.). The one or more connection credential may not be specific to the network access point. The one or more connection credential may be specific to a network provider associated with the network access point. The user may be a subscriber to the network provider. A second user (e.g., subscriber) may have possession and/or control of the network access point. The second user may use one or more network access point specific credential to request connection between a second user device and the network via the network access point. The network access point may determine a signal-to-noise ratio (SNR) between the first user device and the network access point. The network access point may transmit the determined SNR to an authentication server. The authentication server may compare the determined SNR to an SNR threshold and grant access to the network if the SNR is above the SNR threshold. The network access point may grant the second device access to the network without concern of the SNR of the associated request.

A network access point may receive a request to connect from a device. The network access point may determine a SNR between the device and the network access point based on the request. The network access point may transmit an access request to an authentication server on behalf of the device, wherein the access request comprises the SNR. The authentication server may compare the SNR to an SNR threshold and base an access grant or denial on the comparison of the SNR to the SNR threshold. The authentication server may return the access grant or denial to the network access point. The network access point may transmit an indication of the access grant or denial to the device. In the event of an access denial, a message returned to the device may indicate that denial was based on too low of an SNR between the device and the network access point.

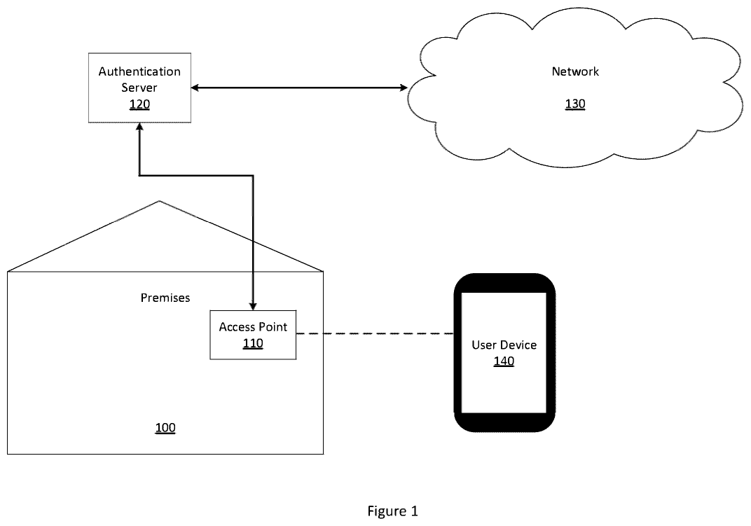

FIG. 1 shows an example environment for SNR-based connection admission control. The environment may comprise a premises 100, a network access point 110, an authentication server 120, a network 130, and a user device 140. Although shown outside the network 130, the authentication server 120 may reside on the edge of the network 130 or inside the network 130. Other configurations may be used.

The premises 100 may be associated with a location that provides network access to one or more devices. The premises 100 may be associated with a first user of a network provider service. The premises 100 may be residential, commercial, industrial, etc. The first user may be an individual, group of individuals (e.g., family, household, etc.), an entity, etc. The premises 100 may associated with a private or public network service. The premises 100 may be associated with a public hotspot network.

The network access point 110 may be associated with the network provider. The network access point 110 may be associated with the first user. The network access point 110 may comprise a hot spot, modem, gateway, access point, etc. The network access point 110 may broadcast one or more service set identifiers (SSIDs) to allow user devices to request admission to the network. The network access point 110 and the one or more SSIDs may be associate with at least a public network.

The network access point 110 may broadcast a first service set identifier (SSID). The first SSID may be associated with the first user (e.g., subscriber service). The first user may provide a first name for the first SSID. The first user may set first one or more credential (e.g., key, password, approved device MAC addresses, etc.) for accessing the network via the first SSID. The network access point 110 may broadcast a second SSID. The second SSID may be associated with the network provider. The network provider may provide a second name for the second SSID. The second name may be a name that is broadcast from a plurality of network access points associated with the network provider. The network provider may set second one or more credential (e.g., key, password, approved device MAC addresses, etc.) for accessing the network via the second SSID. The second one or more credential may be common across network access points broadcasting the second SSID. Any number of SSID may be used.

The authentication server 120 may determine if a device, such as the user device 140, requesting access to the network 130 via a network access point, such as the network access point 110, should be granted access to the network 130. The authentication server 120 may comprise an authentication, authorization, and account (AAA) server. The authentication server 120 may identify a user associated with a device and/or identify the device requesting access to the network 130. The authentication server 120 may grant or deny the device access to the network 130. The authentication server 120 may track activities of the device while the device accesses the network 130. The authentication server 120 may use a Remote Authentication Dial-In User Service (RADIUS) networking protocol. The authentication server 120 may comprise connection admission control logic. The connection admission control logic may be based, at least in part, on a signal-to-noise ratio.

The network 130 may comprise one or more public portion. The network 130 may comprise one or more private portion. The network 130 may comprise the Internet. The network provider may provide access to the network 100 via one or more network access points, such as the network access point 110.

The user device 140 may be associated with a user such as a second user. The user device 140 may be a smartphone, wearable computing device, tablet, laptop computer, etc.

The user device 140 may receive one or more SSID from the network access points 110. The user device 140 may transmit a request to access the network 130 using the received SSID to the network access point 110. The network access point 110 or a network device may determine a signal-to-noise ratio (SNR) in the request. The determination of SNR may be based on a determination of a difference between a received signal value and a noise value (e.g., noise floor). Various noise values may be set or used and may be changed, as described herein. Signal values may be measured using various methods and equipment. Signal values may be measured using various known techniques and may be based on reception device, software hardware, and platform specifications.

Once the SNR between the user device 140 and the network access point 110 is determined, the network access point 110 may transmit an access query to the authentication server 120, wherein the access query comprises the SNR. The authentication server 120 may comprise the SNR to a SNR threshold. If the SNR is less than the SNR threshold, then the authentication server 120 may deny the user device 140 access to the network 130. The authentication server 120 may transmit an access denial message to the network access point 110, wherein the access denial message comprises an indication that the SNR between the user device 140 and the network access point 110 is too low. The network access point 110 may transmit an acknowledgment to the user device 140, wherein the acknowledgement message comprises an indication that the SNR between the user device 140 and the network access point 110 is too low.

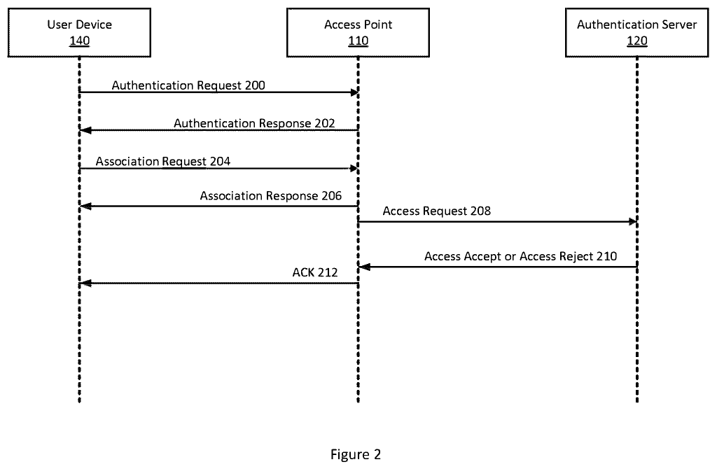

FIG. 2 shows an example sequence diagram for SNR-based connection admission control for a network access point with an open SSID. In an aspect, RADIUS parameters may be configured to facilitate the process shown in the sequence diagram. The sequence diagram may comprise the user device 140 in FIG. 1, the network access point 110 in FIG. 1, and the authentication server 120 in FIG. 1. The network access point 110 may broadcast an open SSID. The user device 140 may receive the open SSID via the broadcast.

Based at least on the received open SSID, the user device 140 may transmit an authentication request 200 to the network access point 110. Based at least on the authentication request 200, the network access point 110 may transmit an authentication response 202 to the user device 140. Based at least on the authentication response 202, the user device 140 may transmit an association request 204 to the network access point 110. Based at least on the association request 204, the network access point 110 may transmit an association response 206 to the user device 140.

Based on the authentication request 200, the association request 204, or both, the network access point 110 may determine a signal-to-noise ratio (SNR) between the user device 140 and the network access point 110. The network access point 110 may transmit an access request 208 to the authentication server 120. The access request 208 may comprise the SNR. The access request 208 may comprise the SNR and an identifier associated with the network access point 110 as an attribute value pair (AVP). RADIUS parameters may be set such that the network access point 110 needs to send an access request, with a determined SNR and identifier associated with the network access point 110, to the authentication server 120 when a user device attempts to connect via the open SSID.

The authentication server 120 may compare the SNR in the access request 208 to an SNR threshold. If the SNR is lower than the SNR threshold, then the authentication server 120 may deny (e.g., reject, refuse, etc.) access to a network, such as the network 130 in FIG. 1. The authentication server 120 may transmit an access accept or access reject message 210 to the network access point 110, wherein the access accept or access reject message 210 is based at least in part on the comparison of the SNR to the SNR threshold. In the event that the access was denied because of too low of an SNR, the access reject message 210 may comprise an indication of the too low SNR.

Based at least on the access accept or access reject message 210, the network access point 110 may transmit an acknowledgement (or ACK) 212 to the user device 140. In the event that the access was denied because of too low of an SNR, the acknowledgement 212 may comprise an indication of the too low SNR. The indication of the too low SNR may comprise an error message. The error message may comprise “SNR Value is less than allowed”. The error message may comprise “low SNR”. The error message may comprise “ERR_SNR_DENY”. Other messaging and protocols may be used.

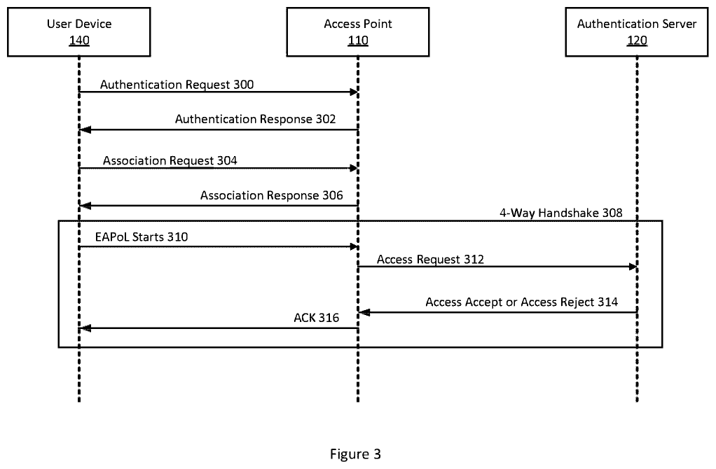

FIG. 3 shows an example sequence diagram for SNR-based connection admission control for a network access point with a secure SSID. In an aspect, RADIUS parameters may be configured to facilitate the process shown in the sequence diagram. The sequence diagram may comprise the user device 140 in FIG. 1, the network access point 110 in FIG. 1, and the authentication server 120 in FIG. 1. The network access point 110 may cause to be transmitted (e.g., broadcast) a secure SSID. The user device 140 may receive the secure SSID via the broadcast.

Based at least on the received secure SSID, the user device 140 may transmit an authentication request 300 to the network access point 110. Based at least on the authentication request 300, the network access point 110 may transmit an authentication response 302 to the user device 140. Based at least on the authentication response 302, the user device 140 may transmit an association request 304 to the network access point 110. Based at least on the association request 304, the network access point 110 may transmit an association response 306 to the user device 140.

A 4-way handshake process 308 may begin based at least on the associated response 306. The 4-way handshake process 308 may comprise an extensible authentication protocol over local area network (EAPoL) messaging protocol. The 4-way handshake process 308 may comprise an EAPol-Start 310, an access request 312, an access accept or access reject 314, and an acknowledgement (or ACK) 316. The EAPoL-Start 310 may be transmitted from the user device 140 to the network access point 110.

Based on the authentication request 300, the association request 304, the EAPoL-Start 310, or any combination of the foregoing, the network access point 110 may determine a signal-to-noise ratio (SNR) between the user device 140 and the network access point 110. Based at least on the EAPoL-Start 310, the network access point 110 may transmit the access request 312 to the authentication server 120. The access request 312 may comprise the SNR. The access request 312 may comprise the SNR and an identifier associated with the network access point 110 as an attribute value pair (AVP). RADIUS parameters may be set such that the network access point 110 needs to send an access request, with a determined SNR and identifier associated with the network access point 110, to the authentication server 120 when a user device attempts to connect via the secure SSID.

The authentication server 120 may compare the SNR in the access request 312 to an SNR threshold. If the SNR is lower than the SNR threshold, then the authentication server 120 may deny (e.g., reject, refuse, etc.) access to a network, such as the network 130 in FIG. 1. In a third portion of the 4-way handshake process 308, the authentication server 120 may transmit the access accept or access reject message 314 to the network access point 110, wherein the access accept or access reject message 314 is based at least in part on the comparison of the SNR to the SNR threshold. In the event that the access was denied because of too low of an SNR, the access reject message 314 may comprise an indication of the too low SNR.

Based at least on the access accept or access reject message 314, the network access point 110 may transmit the acknowledgement (or ACK) 314 to the user device 140 and complete the 4-way handshake process 308. In the event that the access was denied because of too low of an SNR, the acknowledgement 314 may comprise an indication of the too low SNR. The indication of the too low SNR may comprise an error message. The error message may comprise “SNR Value is less than allowed”. The error message may comprise “low SNR”. The error message may comprise “ERR_SNR_DENY”.

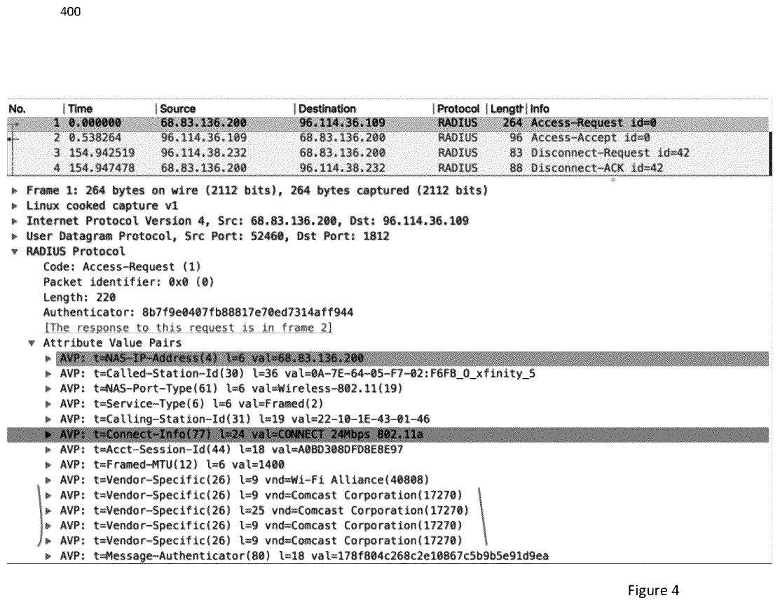

FIG. 4 shows example authentication server communication (e.g., packet, frame, etc.) information. The example authentication server communication information may be organized in a display 400. The example authentication server packet information may comprise one or more authentication, authorization, and account (AAA) communications. The display 400 may comprise a list of communications (e.g., packets, frames, etc.). The communications may comprise a number, a time, a source, a destination, a protocol, a length, and an information field. The number may comprise a serial ordering of the communications as the communications were created. The number may comprise an assigned value for internal accounting of communications by a program creating the screen 400. The time may comprise a number indicative of time, such as seconds. The time may indicate a time since a first communication was recorded, sent, received, etc. The source and/or the destination may comprise a location associated with a device. The source and/or the destination may comprise an internet protocol (IP) address. The source may be associated with a location where a communication originates. The destination may be associated with a location to which a communication is addressed. The protocol may comprise a protocol the communication uses. The protocol may be Remote Authentication Dial-In User Service (RADIUS) protocol. The length may comprise a number indicative of a number of bytes in the communication. The information field may comprise information regarding the communication. The information regarding the communication may comprise a type of communication (e.g., “Access-Request”, Access-Access”, “Access-Reject”, “Disconnect-Request”, “Disconnect-ACK”, etc.). The information regarding the communication may comprise an identifier. The identifier may identify a communication (e.g., packets, frames, etc.). The identifier may comprise a value assigned by an external computing device or for use by an external computing device.

When a communication in the list is highlighted, more details may be displayed. In screen 400, communication number 1 is highlighted. Detailed information associated with communication number 1 are displayed below the list of communications. Each line of information comprising a triangle icon may have an expandable option to show more related lines. In screen 400, “RADIUS Protocol” is expanded, and “Attribute Value Pairs” is expanded under “RADIUS Protocol”. Information shown under “Attribute Value Pairs” (AVP) may comprise network provider (e.g., vendor, internet service provider (ISP), etc.) specific information. Information shown under “AVP” may comprise an indication of whether a communication is open or secure, a media access control (MAC) address associated with a network access point, a virtual local area network (VLAN), a signal-to-noise ratio (SNR) associated with the communication, etc.

If a connection between a user device and a network access point is determined to have a signal-to-noise ratio (SNR) lower than a SNR threshold, then an access request may be rejected with an error message. The error message may comprise “Low SNR Indication”. As an example, the SNR threshold may be 15. An SNR associated with an access request may be 13. An associated AAA log may show that the user device received an access rejection, an error code of “ERR-SNR-DENY”, and an error message of “SNR Value is less than allowed”.

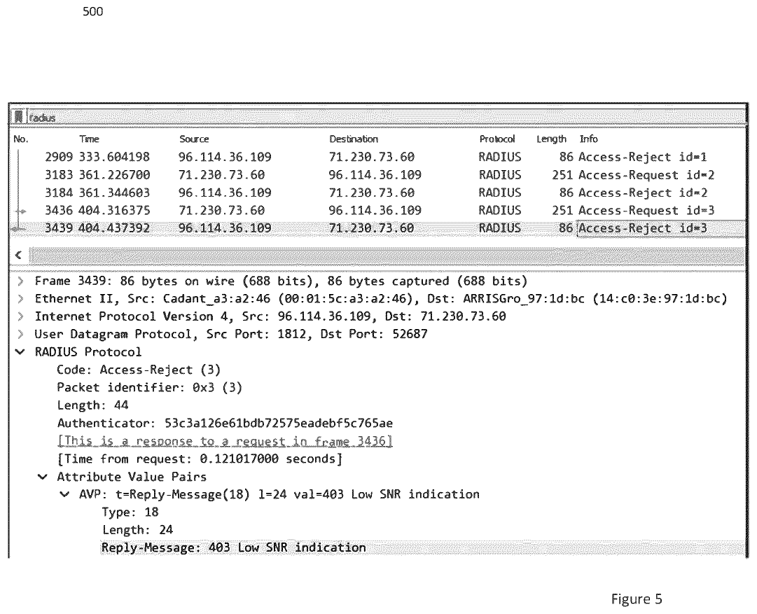

FIG. 5 shows example access reject packet information. The example access reject packet information may be organized in a display 500. The information shown in display 500 may be organized similarly to the information shown in display 400 in FIG. 4. The difference between the communications shown in display 400 and in display 500 is that every communication listed in display 500 is an Access-Reject or an Access-Request with a corresponding Access-Reject. As shown in display 500, frame 3439 comprised an Access-Reject and was sent based at least on the Access-Request sent in frame 3436. An error message of “403 Low SNR indication” was sent to a device associated with an Internet Protocol (IP) address of 71.230.73.60. FIG. 5 illustrates a non-limiting example. Other messages and content may be used to indicate an accept or reject condition.

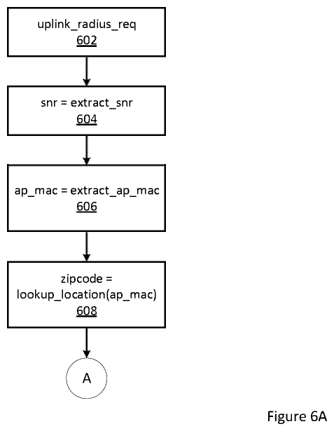

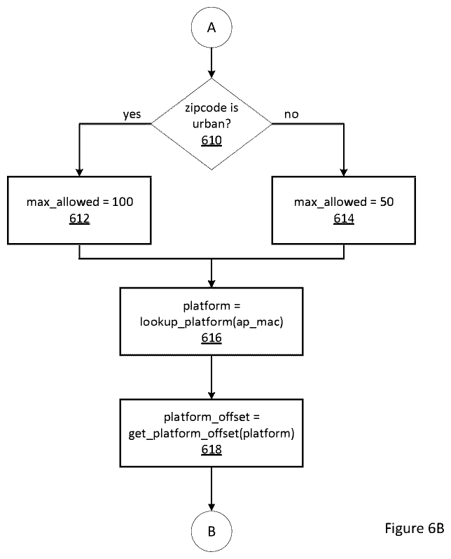

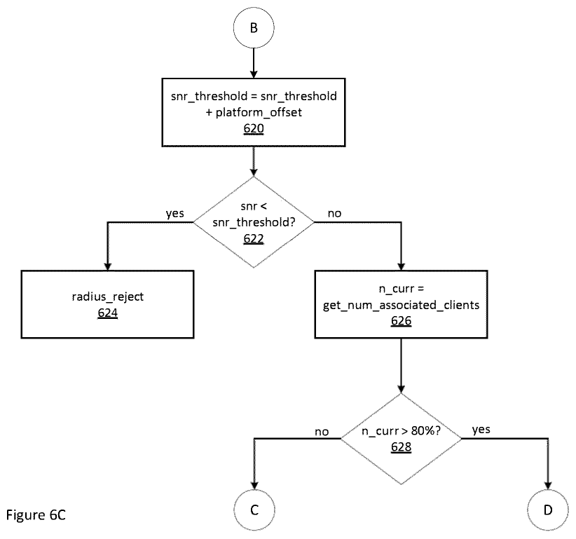

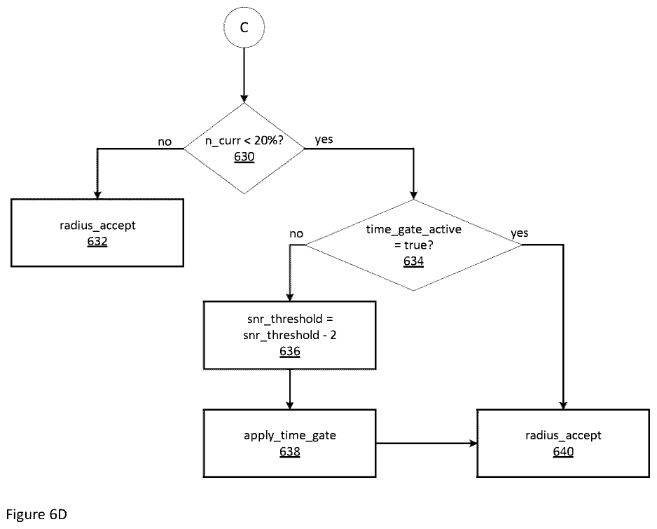

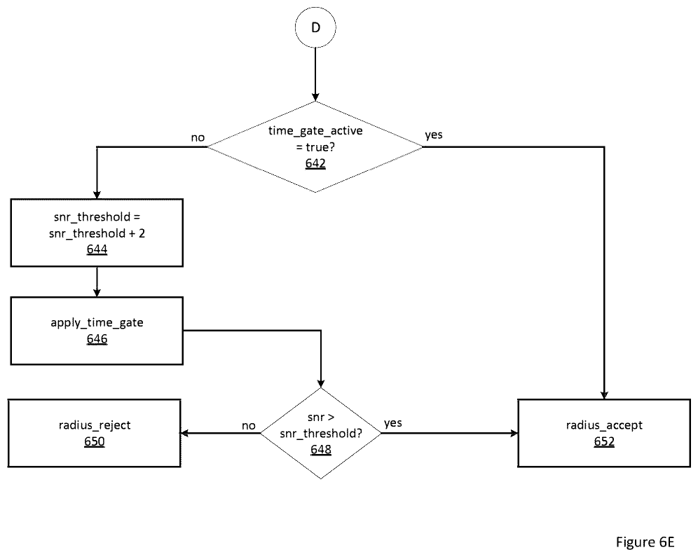

FIGS. 6A-6E show an example process for SNR-based connection admission control. The example process may be executed by an authentication server or other network equipment. An access request may be received, at 602. The access request may implement various protocols and formats to effect the indication that a device is requesting access to a network or network service. As an example, the access request may comprise a Remote Authentication Dial-In User Service (RADIUS) Access-Request. The access request may be associated with an association request originating from a user device and transmitted to a network access point. The access request may be created by the network access point based at least on to the associated request. The access request may comprise a signal-to-noise ratio (SNR) associated with the SNR between the user device and the network access point. The SNR may be based on the association request. The access request may comprise a media access control (MAC) address associated with the network access point.

A signal-to-noise ratio (SNR) may be determined from (e.g., extracted from) the access request, at 604. The SNR may be the SNR between the user device and the network access point. The determination of SNR may be based on a determination of a difference between a received signal value and a noise value (e.g., noise floor). Various noise values may be set or used and may be changed, as described herein. Signal values may be measured using various methods and equipment. Signal values may be measured using various known techniques and may be based on reception device, software hardware, and platform specifications. A media access control (MAC) address may be extracted from the access request, at 606. The extracted MAC address may be the MAC address associated with the network access point. As is understood, communications over various protocols on a network include information such as network addresses or a MAC address. As such, the Mac address may be determined from the access request message itself. However, other means may be used. The extracted MAC address may be used to determine a zip code, at 608. MAC addresses may be associated with locations and may be stored and referenced in look-up tables or other data stores. As an example, the determined zip code may be associated with a location associated with the network access point.

Turning to FIG. 6B, a determination may be made whether the determined zip code is in a populated area (e.g., an urban area), at 610. Such a determination may be based on stored information regarding a condition such as population, or user density, or other factors that have been associated with the zip code, which may be referenced. If the determined zip code meets the condition, then a maximum number of allowed devices may be set to a first level (e.g., 100), at 612. The condition and the number of allowed devices may be set at any level. If the determined zip code does not meet the condition, the maximum number of allowed devices may be set to a second level (e.g., 50), at 614. The condition and the number of allowed devices may be set at any level. One or more of the first level and the second level of allowed device may be based on the number of potential device or users in a given area. The second level may be less than the first level.

The extracted MAC address may be used to determine a platform associated with the network access point, at 616. The MAC address may be compared to a data store such as a look-up table to access the platform information. Other means may be used. The platform may be associated with a network provider, subscription tier, hardware capabilities, etc. At 618, a platform offset may be determined based on the determined platform. The platform offset may be a pre-determined adjustment value based upon the platform (e.g., hardware, software, firmware, etc.) associated with the network access point. Based on the platform specification, a set value may be used, for example extracted from a look-up table or other data store. The platform offset may be based at least in part on a network provider, subscription tier, hardware capabilities, etc.

Turning to FIG. 6C, an SNR threshold may be set or adjusted based on the platform offset, at 620. The platform offset may be added to a standard (e.g., default, etc.) SNR threshold to determine an SNR threshold for the platform associated with the network access point. The standard threshold may be pre-determined. The standard threshold may be adjusted based on various conditions or feedback. At 622, a determination may be made whether the extracted SNR is less than the SNR threshold. If the extracted SNR is determined to be less than the SNR threshold, then access may be rejected (e.g., rejection message returned), at 624. As an illustrative example, the access rejection may comprise a RADIUS Access-Reject. If the extracted SNR is determined to be not less than the SNR threshold, then a current number of user devices associated with the network access point may be determined, at 626. The number of user devices may be determined based on current network information, connection information, or the like.

At 628, a determination may be made of if the determined current number of user devices associated with the network access point exceeds a first device threshold (e.g., 80% of the maximum user devices allowed). If the determined current number of user devices associated with the network access point is not more than the threshold amount, then the process may proceed to 630. If the determined current number of user devices associated with the network access point exceeds the first device threshold, then the process may proceed to 642.

Turning to FIG. 6D, at 630, a determination may be made whether the current number of user devices associated with the network access point is less than a second device threshold (e.g., 20% of the maximum user devices allowed). If the current number of user devices associated with the network access point is not less than the second device threshold, then an access accept may be returned, at 632. The access accept may comprise a RADIUS Access-Accept. If the current number of user devices associated with the network access point is less than the second device threshold, then the process may proceed to step 634.

At 634, a determination may be made whether a time gate is active. A time gate may be any time period set as a threshold gating mechanism. As such, when the time gate is active, certain actions may or may not be implemented based on whether the time gate has been exceeded. When the time gate is not active, the timing condition does not apply. If a determination is made that the time gate is not active, then the process may move to 636. If a determination is made that the time gate is not active, then the process may move to 640.

At 636, the SNR threshold may be reduced by an amount. As an example, the SNR threshold may be reduced by two decibels. Other adjustment steps may be used. The reduction may allow devices with lower SNR to be allowed to join the network. As such, applying increases or decreases to the SNR threshold, the process may provide admission controls to effect overall connection quality and user experience. At 638, a time gate may be activated (e.g., applied, initiated, etc.). As described at 634 (and 642), during an active period of the time gate, device requests may be accepted without adjustment to the SNR threshold. At 640, an access accept may be returned. The access accept may comprise a RADIUS Access-Accept. Other messages or protocols may be used.

Turning to FIG. 6E, at 642, a determination is made whether a time gate is active. If a determination is made that the time gate is not active, then the process may move to step 644. If a determination is made that the time gate is active, then the process may move to step 652. At step 644, the SNR threshold may be increased by an amount. As an example, the SNR threshold may be increased by two decibels. Other adjustment steps may be used. The increase may cause devices with lower SNR to be rejected from joining the network. As such, applying increases or decreases to the SNR threshold, the process may provide admission controls to effect overall connection quality and user experience. At step 646, a time gate may be activated (e.g., applied, initiated, etc.).

At step 648, a determination may be made whether the SNR associated with the requesting device is greater than the SNR threshold. If the SNR is greater than the SNR threshold, then an access accept may be returned, at 652. The access accept may comprise a RADIUS Access-Reject. Other protocols and messaging may be used. If the SNR is not greater than the SNR threshold, then an access reject may be returned, at 650. The access reject may comprise a RADIUS Access-Accept. Other protocols and messaging may be used.

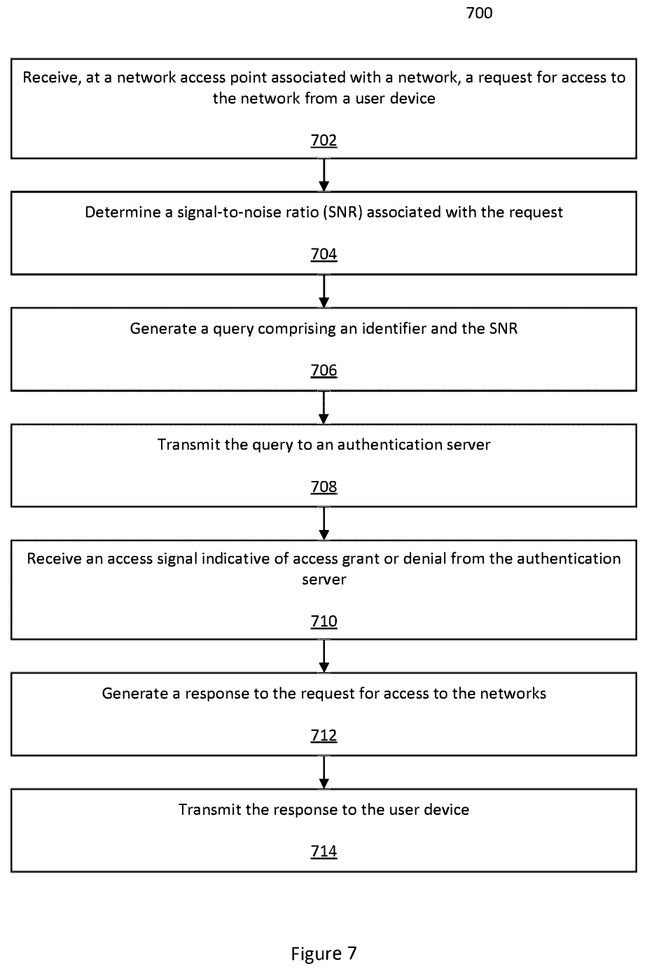

FIG. 7 is a flowchart of an example process 700. In some implementations, one or more process blocks of FIG. 7 may be performed by one or more devices, such as an authentication server in cooperation with a network access point.

As shown in FIG. 7, process 700 may include receiving, at a network access point associated with a network, a request for access to the network from a user device (block 702). As also shown in FIG. 7, process 700 may include determining, based on an analysis of a signal between the user device and the network access point, a signal-to-noise ratio (SNR) associated with the request (block 704). One or more devices may determine, based on an analysis of a signal between the user device and the network access point, a signal-to-noise ratio (SNR) associated with the request, as described herein.

As further shown in FIG. 7, process 700 may include generating a query having an identifier and the SNR (block 706). The identifier may comprise a media access control (MAC) address associated with the network access point.

As also shown in FIG. 7, process 700 may include transmitting the query to an authentication server, where the authentication server is configured to grant or deny access to the network based on at least a comparison of the SNR to a SNR threshold (block 708). Transmitting the query to an authentication server may comprise initiating a 4-way handshake process. Transmitting the query to an authentication server may begin an Extensible Authentication Protocol (EAP) over local area network (LAN) process. Transmitting the query to an authentication server may occur after an authentication request is received by the network access point from the user device. For example, the network access point may transmit the query to an authentication server, where the authentication server is configured to grant or deny access to the network based on at least a comparison of the SNR to a SNR threshold, as described herein.

As further shown in FIG. 7, process 700 may include receiving an access signal indicative of access grant or denial from the authentication server (block 710). The network access point may receive an access signal indicative of access grant or denial from the authentication server, as described above. As also shown in FIG. 7, process 700 may include generating, based on the request for access and the access signal, a response to the request for access to the networks (block 712). As further shown in FIG. 7, process 700 may include transmitting the response to the user device (block 714). The network access point may transmit the response to the user device, as described above.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

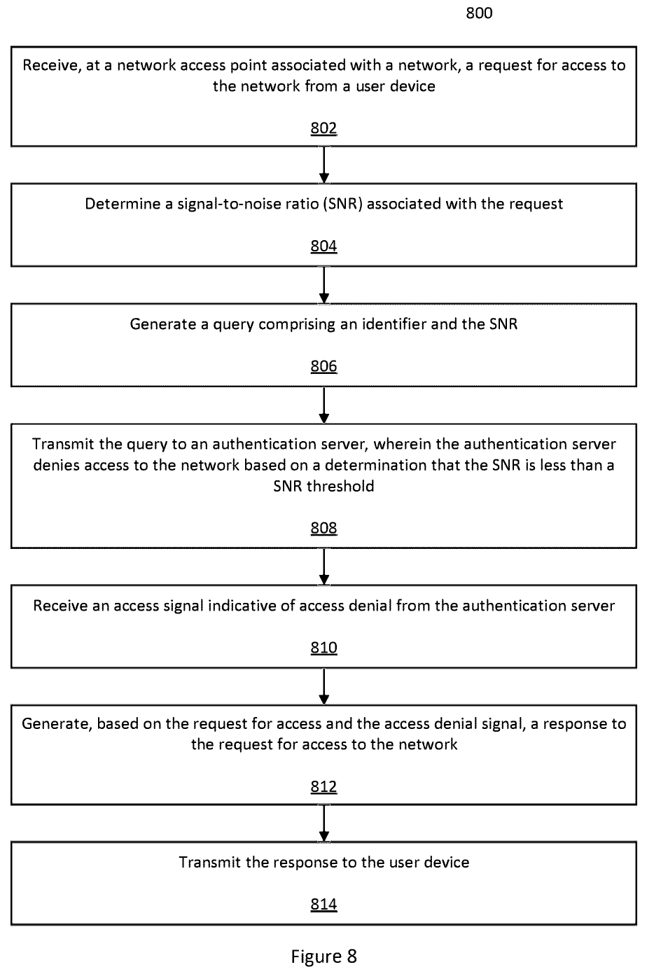

FIG. 8 is a flowchart of an example process 800. In some implementations, one or more process blocks of FIG. 8 may be performed by one or more devices, such as an authentication server in cooperation with a network access point.

As shown in FIG. 8, process 800 may include receiving, at a network access point associated with a network, a request for access to the network from a user device (block 802). As also shown in FIG. 8, process 800 may include determining, based on an analysis of a signal between the user device and the network access point, a signal-to-noise ratio (SNR) associated with the request (block 804). As further shown in FIG. 8, process 800 may include generating a query having an identifier and the SNR (block 806). A network access point may generate a query having an identifier and the SNR, as described above. As also shown in FIG. 8, process 800 may include transmitting the query to an authentication server (block 808). The authentication server may deny access to the network based on a determination that the SNR is less than a SNR threshold. As further shown in FIG. 8, process 800 may include receiving an access signal indicative of access denial from the authentication server (block 810). The network access point may receive an access signal indicative of access denial from the authentication server, as described above. As also shown in FIG. 8, process 800 may include generating, based on the request for access and the access denial signal, a response to the request for access to the network (block 812). As further shown in FIG. 8, process 800 may include transmitting the response to the user device (block 814).

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

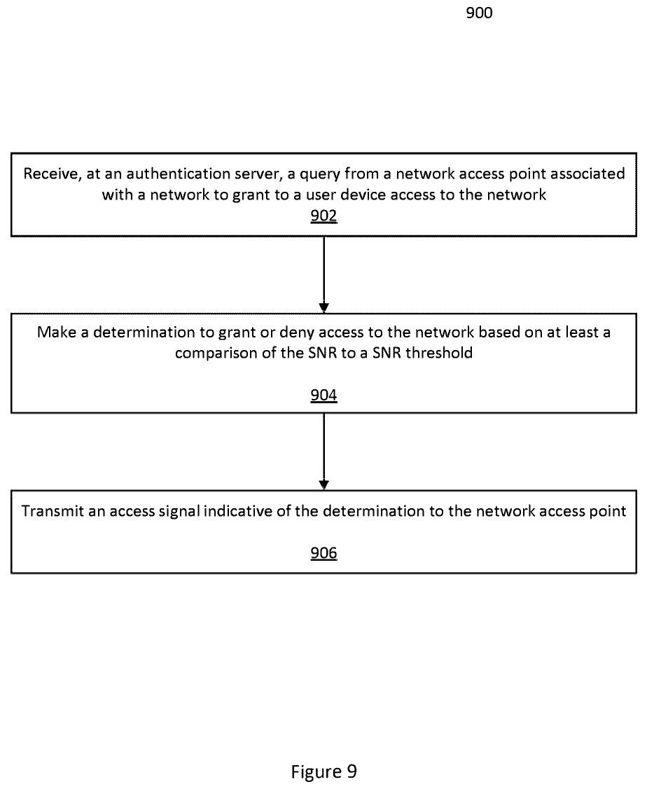

FIG. 9 is a flowchart of an example process 900. In some implementations, one or more process blocks of FIG. 9 may be performed by one or more devices, such as an authentication server in cooperation with a network access point.

As shown in FIG. 9, process 900 may include receiving, at an authentication server, a query from a network access point associated with a network to grant a user device access to the network. The query may include an identifier associated with the network access point and a signal to noise ratio (SNR) based on analysis of a signal between the user device and the network access point. The SNR may be associated with a request for network access originated at the user device and sent to the network access point (block 902). As also shown in FIG. 9, process 900 may include making a determination to grant or deny access to the network based on at least a comparison of the SNR to a SNR threshold (block 904). An authentication server may make a determination to grant or deny access to the network based on at least a comparison of the snr to a snr threshold, as described herein. As further shown in FIG. 9, process 900 may include transmitting an access signal indicative of the determination to the network access point (block 906). An authentication server may transmit an access signal indicative of the determination to the network access point, as described above.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

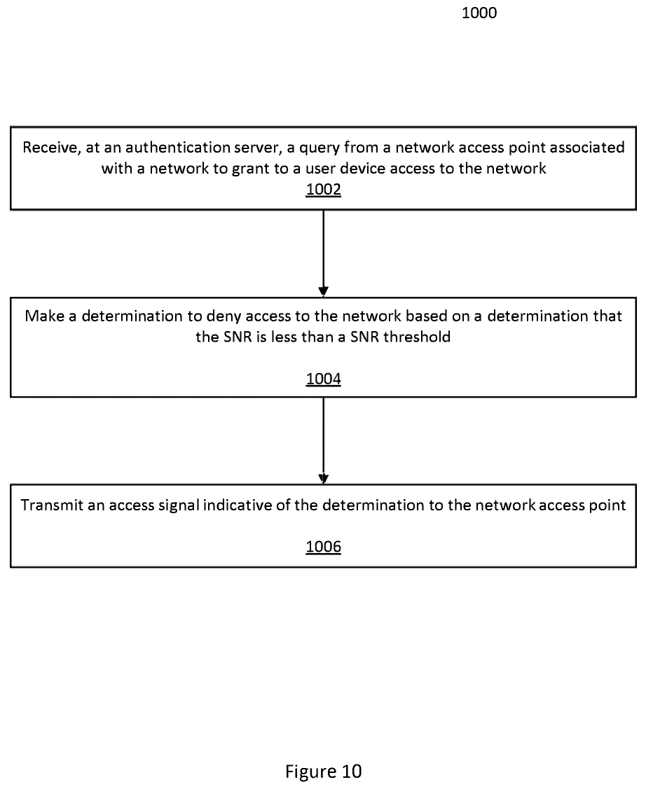

FIG. 10 is a flowchart of an example process 1000. In some implementations, one or more process blocks of FIG. 10 may be performed by one or more devices, such as an authentication server in cooperation with a network access point.

As shown in FIG. 10, process 1000 may include receiving, at an authentication server, a query from a network access point associated with a network to grant to a user device access to the network. The query may include an identifier associated with the network access point and a signal to noise ratio (SNR) based on analysis of a signal between the user device and the network access point. The SNR may be associated with a request for network access originated at the user device and sent to the network access point (block 1002). As also shown in FIG. 10, process 1000 may include making a determination to deny access to the network based on a determination that the SNR is less than a SNR threshold (block 1004). An authentication server may make a determination to deny access to the network based on a determination that the SNR is less than a SNR threshold, as described above. As further shown in FIG. 10, process 1000 may include transmitting an access signal indicative of the determination to the network access point (block 1006). The authentication server may transmit an access signal indicative of the determination to the network access point, as described above.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

The present disclosure may comprise at least the following examples:

Example Clause A: A method comprising: receiving, at a network access point associated with a network, a request for access to the network from a user device; determining, based on an analysis of a signal between the user device and the network access point, a signal-to-noise ratio (SNR) associated with the request; generating a query comprising an identifier and the SNR; transmitting the query to an authentication server, wherein the authentication server is configured to grant or deny access to the network based on at least a comparison of the SNR to a SNR threshold; receiving an access signal indicative of access grant or denial from the authentication server; generating, based on the request for access and the access signal, a response to the request for access to the networks; and transmitting the response to the user device.

Example Clause B: The method of Example Clause A, wherein the network access point is associated with one or more of a private, closed network or an open, public network.

Example Clause C: The method of Example Clause A or Example Clause B, wherein the request for access is associated with the open, public network.

Example Clause D: The method of any one of Example Clauses A-C, wherein the authentication server is associated with a network provider of the open, public network.

Example Clause E: The method of any one of Example Clauses A-D, wherein the network access point is associated with the network provider.

Example Clause F: The method of any one of Example Clauses A-E, wherein the identifier is a media access control (MAC) address associated with the network access point.

Example Clause G: The method of any one of Example Clauses A-F, further comprising initiating, based on grant of access to the network, a 4-way handshake process between the user device, the network access point, and the authentication server.

Example Clause H: The method of any one of Example Clauses A-G, further comprising initiating, based on grant of access to the network, an Extensible Authentication Protocol (EAP) over local area network (LAN) process.

Example Clause I: The method of any one of Example Clauses A-H, wherein the transmitting the query to the authentication server is an access request as part of an authentication, authorization, and accounting (AAA) management system.

Example Clause J: The method of any one of Example Clauses A-I, wherein the transmitting the query to the authentication server is an access request as part of a Remote Authentication Dial-In User Service (RADIUS) protocol.

Example Clause K: The method of any one of Example Clauses A-J, wherein the transmitting the response to the user device comprises causing an error message to appear on the user device, wherein the error message indicates that the SNR is too low to allow access to the network.

Example Clause L: A method comprising: receiving, at a network access point associated with a network, a request for access to the network from a user device; determining, based on an analysis of a signal between the user device and the network access point, a signal-to-noise ratio (SNR) associated with the request; generating a query comprising an identifier and the SNR; transmitting the query to an authentication server; receiving an access signal indicative of access denial from the authentication server, wherein the access denial is based at least in part on a determination that the SNR is less than a SNR threshold; generating, based on the request for access and the access denial signal, a response to the request for access to the network; and transmitting the response to the user device.

Example Clause M: The method of Example Clause L, wherein the network access point is associated with one or more of a private, closed network or an open, public network.

Example Clause N: The method of Example Clause L or Example Clause M, wherein the request for access is associated with the open, public network.

Example Clause O: The method of any one of Example Clauses L-N, wherein the authentication server is associated with a network provider of the open, public network.

Example Clause P: The method of any one of Example Clauses L-O, wherein the network access point is associated with the network provider.

Example Clause Q: The method of any one of Example Clauses L-P, wherein the identifier is a media access control (MAC) address associated with the network access point.

Example Clause R: The method of any one of Example Clauses L-Q, wherein the transmitting the query to the authentication server is an access request as part of an authentication, authorization, and accounting (AAA) management system.

Example Clause S: The method of any one of Example Clauses L-R, wherein the transmitting the query to the authentication server is an access request as part of a Remote Authentication Dial-In User Service (RADIUS) protocol.

Example Clause T: The method of any one of Example Clauses L-S, wherein the transmitting the response to the user device comprises causing an error message to appear on the user device, wherein the error message indicates that the SNR is too low to allow access to the network.

Example Clause U: A method comprising: receiving, at an authentication server and from a network access point associated with a network, a query comprising an identifier associated with the network access point and a signal to noise ratio (SNR) based on analysis of a signal between a user device and the network access point, wherein the SNR is associated with a request for network access by the user device; determining to grant or deny access to the network based on at least a comparison of the SNR to a SNR threshold; and transmitting, via the authentication server and to the network access point, an access signal indicative of a determination to grant or deny access to the network.

Example Clause V: The method of Example Clause U, wherein the network access point is associated with one or more of a private, closed network or an open, public network.

Example Clause W: The method of Example Clause U or Example Clause V, wherein the request for access is associated with the open, public network.

Example Clause X: The method of any one of Example Clauses U-W, wherein the authentication server is associated with a network provider of the open, public network.

Example Clause Y: The method of any one of Example Clauses U-X, wherein the network access point is associated with the network provider.

Example Clause Z: The method of any one of Example Clauses U-Y, wherein the identifier is a media access control (MAC) address associated with the network access point.

Example Clause AA: The method of any one of Example Clauses U-Z, further comprising initiating, based on grant of access to the network, a 4-way handshake process between the user device, the network access point, and the authentication server.

Example Clause AB: The method of any one of Example Clauses U-AA, further comprising initiating, based on grant of access to the network, an Extensible Authentication Protocol (EAP) over local area network (LAN) process.

Example Clause AC: The method of any one of Example Clauses U-AB, wherein the authentication server is associated with an authentication, authorization, and accounting (AAA) management system.

Example Clause AD: The method of any one of Example Clauses U-AC, wherein the authentication server is configured to communicate via a Remote Authentication Dial-In User Service (RADIUS) protocol.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving, at a network access point associated with a network, a request for access to the network associated with a user device;
determining, based on an analysis of a signal between the user device and the network access point, a signal-to-noise ratio (SNR) associated with the request;
transmitting a query to an authentication server, wherein the query comprises an identifier and the SNR, and wherein the authentication server is configured to grant or deny access to the network based on at least a comparison of the SNR to a SNR threshold;
receiving an access signal indicative of access grant or denial from the authentication server; and
transmitting, to the user device and based on the request for access and the access signal, a response associated with the request for access to the networks.

2. The method of claim 1, wherein the request for access is associated with an open, public network.

3. The method of claim 1, wherein the identifier is a media access control (MAC) address associated with the network access point.

4. The method of claim 1, further comprising initiating, based on grant of access to the network, a 4-way handshake process between the user device, the network access point, and the authentication server.

5. The method of claim 1, further comprising initiating, based on grant of access to the network, an Extensible Authentication Protocol (EAP) over local area network (LAN) process.

6. The method of claim 1, wherein the transmitting the query to the authentication server is an access request as part of an authentication, authorization, and accounting (AAA) management system.

7. The method of claim 1, wherein the transmitting the query to the authentication server is an access request as part of a Remote Authentication Dial-In User Service (RADIUS) protocol.

8. The method of claim 1, wherein the transmitting the response to the user device comprises causing an error message to appear on the user device, wherein the error message indicates that the SNR is too low to allow access to the network.

9. A method comprising:
receiving, at a network access point associated with a network, a request for access to the network from a user device;
determining, based on an analysis of a signal between the user device and the network access point, a signal-to-noise ratio (SNR) associated with the request;
transmitting a query to an authentication server, wherein the query comprises an identifier and the SNR;
receiving an access signal indicative of access denial from the authentication server, wherein the access denial is based at least in part on a determination that the SNR is less than a SNR threshold; and
transmitting, to the user device and based on the request for access and the access signal, a response associated with the request for access to the networks.

10. The method of claim 9, wherein the identifier is a media access control (MAC) address associated with the network access point.

11. The method of claim 9, wherein the transmitting the query to the authentication server is an access request as part of an authentication, authorization, and accounting (AAA) management system.

12. The method of claim 9, wherein the transmitting the query to the authentication server is an access request as part of a Remote Authentication Dial-In User Service (RADIUS) protocol.

13. The method of claim 9, wherein the transmitting the response to the user device comprises causing an error message to appear on the user device, wherein the error message indicates that the SNR is too low to allow access to the network.

14. A method comprising:
receiving, at an authentication server and from a network access point associated with a network, a query comprising an identifier associated with the network access point and a signal to noise ratio (SNR) based on analysis of a signal between a user device and the network access point, wherein the SNR is associated with a request for network access by the user device;
determining to grant or deny access to the network based on at least a comparison of the SNR to a SNR threshold; and
transmitting, via the authentication server and to the network access point, an access signal indicative of a determination to grant or deny access to the network.

15. The method of claim 14, wherein the request for access is associated with an open, public network.

16. The method of claim 14, wherein the identifier is a media access control (MAC) address associated with the network access point.

17. The method of claim 14, further comprising initiating, based on grant of access to the network, a 4-way handshake process between the user device, the network access point, and the authentication server.

18. The method of claim 14, further comprising initiating, based on grant of access to the network, an Extensible Authentication Protocol (EAP) over local area network (LAN) process.

19. The method of claim 14, wherein the authentication server is associated with an authentication, authorization, and accounting (AAA) management system.

20. The method of claim 14, wherein the authentication server is configured to communicate via a Remote Authentication Dial-In User Service (RADIUS) protocol.
